(19) United States
(12) Patent Application Publication
(10) Pub. No.: US 2026/0295724 A1
(43) Pub. Date: Oct. 1, 2026

(54) LASER TREATMENT FACILITY FOR APPLYING LASER TREATMENT TO A CONTAINER

(71) Applicant: SIDEL PARTICIPATIONS, Octeville-sur-Mer (FR)

(72) Inventors: Guy FEUILLOLEY, OCTEVILLE- SUR-MER (FR); Véronique BERNARD, OCTEVILLE- SUR-MER (FR); Frédéric LECOMTE, OCTEVILLE- SUR-MER (FR); Cyrille SAVARY, OCTEVILLE-SUR-MER (FR); Daniel DIESNIS, OCTEVILLE- SUR-MER (FR); Guillaume CHAUVIN, OCTEVILLE- SUR-MER (FR)

(21) Appl. No.: 19/631,621

(22) Filed: Mar. 27, 2026

(30) Foreign Application Priority Data
Mar. 31, 2025 (FR) 2503277

(51) Int. Cl. B23K 26/08; B23K 101/04; B65G 29/00; B65G 43/08; B65G 47/244; B65G 47/86

(52) U.S. Cl. CPC B23K 26/0823; B65G 29/00; B65G 43/08; B65G 47/2445; B65G 47/847; B23K 2101/04; B65G 2201/0244; B65G 2203/0225; B65G 2203/044

(57) ABSTRACT

Disclosed are various embodiments of a laser treatment facility having a laser treatment device designed to apply laser treatment to a treatment area of a container in an area to be treated. The laser treatment facility also includes a detection device designed to detect the position of the area to be treated and a device for orienting the container designed to rotate the container by an angle of rotation determined according to the detected position of the area to be treated. The orientation device is designed to place the area to be treated in front of the laser treatment device.

### CROSS-REFERENCE TO RELATED APPLICATIONS

This application claims the benefit of French Application No. FR2503277, filed Mar. 31, 2025, the entire contents of which is hereby incorporated herein by reference.

### BACKGROUND

Laser treatment can currently be performed on a succession of containers in a laser treatment facility in which the containers are transported by a wheel in front of laser treatment devices carried by the wheel. Such a facility allows the laser treatment to be applied to a large number of containers at a high rate. In the case of containers with a uniform profile, such as cylindrical and symmetrical bottles, the introduction of the containers onto the wheel does not pose any particular problem since the laser treatment can be applied without concern for the angular positioning of the containers relative to the laser treatment devices.

However, containers often have embossed patterns forming raised and recessed areas on the container walls, making them asymmetrical. Such patterns are designed, for example, to give the containers a particular appearance, such as representing the contents of the container or the identity of the manufacturer of those contents. The pattern may be a logo or a shape that identifies the product contained in the container and/or its manufacturer.

In the case of such asymmetrical containers, it is planned, for example, to leave an area without a pattern on which the laser treatment is to be applied. However, the laser treatment facility mentioned above can then no longer be used in a simple manner, as there is no guarantee that the area to be treated on each container will be in front of a laser treatment device when that container is transported by the wheel. Accordingly, it has been found that needs exist for a laser treatment facility for a container in which laser treatment can be applied to an area to be treated extending over only part of the body of the container. It is to the provision of meeting these and other needs that the present invention is primarily directed.

### SUMMARY

Embodiments of the present disclosure provide for a facility for laser marking containers.

An embodiment of the present disclosure includes a laser treatment facility for at least one container, the container including a body extending along an axis and at least one area to be treated extending over a part of the body of the container. The facility can include a transport device for transporting the container, designed to transport the container along a path of movement. The facility can also include at least one laser treatment device for laser treatment of the container, the laser treatment device extending in front of a part of a movement path, and laser treatment device configured to apply laser treatment to the container in the area to be treated. The laser treatment facility can also include a detection device configured to detect a position of the area to be treated upstream of the laser treatment device along the movement path. Also upstream of the upstream of the laser treatment device, the facility can include an orienting device for orienting the container. The orienting device can rotate the container about the axis at an angle of rotation determined according to a detected position of the area to be treated. The orienting device can place the area to be treated in an orientation in which the area to be treated extends in front of the laser treatment device when the container is transported in front of the laser treatment device.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a schematic plan view of part of a laser treatment facility according to various example embodiments;

FIG. 2 is a schematic side view of a detection device of the laser treatment facility of FIG. 1;

FIG. 3 is a schematic side view of a transfer device of the laser treatment facility of FIG. 1;

FIG. 4 is a schematic side view of a part of the laser treatment device of the laser treatment facility of FIG. 1;

FIG. 5 is a schematic side view of a part of a container gripping device in the laser treatment facility of FIG. 1, in a transition position, according to various example embodiments; and

FIG. 6 is a schematic side view of the part of the gripping device of FIG. 5 in a blocking position.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

### General Discussion

In accordance with the purpose(s) of the present disclosure, as embodied and broadly described herein, embodiments of the present disclosure, in some aspects, relate to a laser treatment facility for a container of the aforementioned type.

In general, embodiments of the present disclosure provide for a laser treatment facility for a container that includes a body extending along an axis, the body having at least one area to be treated extending over a part of the body of the container. The facility can include a container transport device, designed to transport the container along a path of movement and at least one device for laser treatment of the container. The laser treatment device extends in front of a part of the path of movement and is configured to apply laser treatment to the container in the area to be treated on the body of said container.

The detection device and the orientation device enable the container to be oriented in an angular position that ensures that the area to be treated is positioned in front of the laser treatment device while the container is being transported by the transport device. Advantageously, such a facility makes it possible to treat non-symmetrical containers at high speed, in particular by continuing to use a wheel carrying laser treatment devices, the containers being introduced onto this wheel with the orientation applied by the orientation device.

The described facility, also referred to as a thermal treatment facility, may have one or more of the following features, taken on their own or in any technically feasible combination. The detection device includes at least one image acquisition device and a container rotation device. The container rotation device is configured to rotate the container about its axis in front of the image acquisition device, the image acquisition device being designed to acquire images of different parts of the container body. The facility can also include an analysis module configured to detect the position of the area to be treated from the images acquired by the image acquisition device.

The facility can also have a transport device that includes an orientation wheel carrying the container rotation device, where the orientation wheel can transport the container over a part of the path of movement, with the container rotating about its axis as it travels over said part of the path of movement. The transport device also includes a treatment wheel carrying the laser treatment device. The treatment wheel can transport the container over a part of the path of movement, where the container is fixed relative to the laser treatment device with the area to be treated in front of said laser treatment device as it moves along said part of the path of movement. The laser treatment device can apply the laser treatment to the area to be treated during movement along said part of the path of movement.

The orientation wheel can be separate from the treatment wheel, the treatment wheel extending downstream of the orientation wheel, with the laser treatment facility having a transfer area in which the container is transferred from the orientation wheel to the treatment wheel. The orientation wheel carries the device for orienting the container, where the orientation device is arranged so that the container is in an angular position in which the area to be treated is in an angular orientation such that the area to be treated extends in front of the laser treatment device when the container is transported by the treatment wheel.

The transport device can include at least one device for gripping the container when it is transported by the orientation wheel and by the treatment wheel. The gripping device can allow the container to rotate about its axis when the container is transported by the orientation wheel and to prevent said rotation when said container is transported by the treatment wheel. The gripping device can maintain the orientation of the container in the transfer area.

The laser treatment device can project a laser beam onto the area to be treated, with the projection of the laser beam being carried out in such a way as to generate bubbles and particles of degraded material throughout all or part of the thickness of a wall of the container body at the area to be treated.

The transport device can also transport a succession of containers along the path of movement, with the laser treatment facility including a plurality of laser treatment devices that can apply laser treatment to the area to be treated on each container in the succession of containers.

Turning now to the drawings, exemplary embodiments are described in detail.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

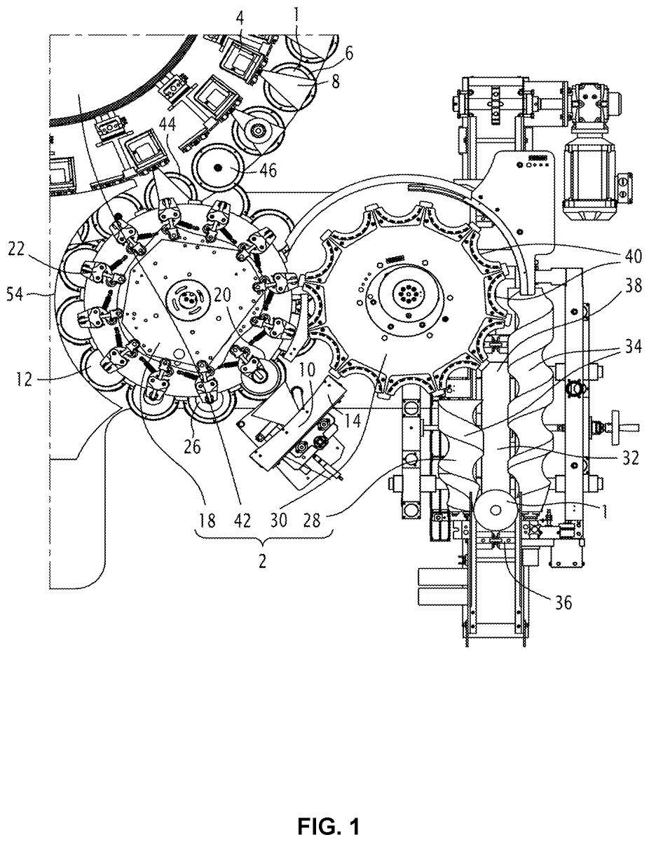

With reference to FIG. 1, a laser treatment facility for at least one container 1 is described, comprising a transport device 2 and at least one laser treatment device 4 for a container 1. Such a laser treatment facility is, for example, designed to apply laser treatment to a series of containers 1, more specifically to a circumscribed area to be treated on each container 1. Such laser treatment is, for example, laser marking of the area to be treated on the or each container 1, as will be described in more detail below.

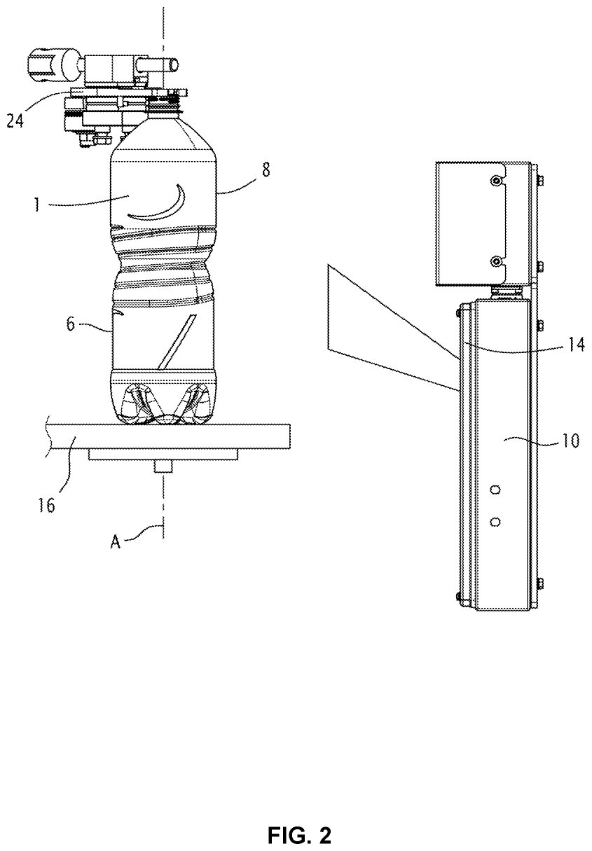

The container 1 comprises a body 6 extending along an axis A (FIGS. 2 to 4) and an area to be treated 8 extending over a part of this body 6. As indicated above, the area to be treated 8 is circumscribed, i.e., it extends over a limited part of the body 6, and is oriented angularly with respect to the axis A. In other words, the body 6 is not symmetrical about the axis A and the area to be treated 8 does not extend all around the body 6 at a given height. The facility is thus particularly suitable when the container 1 has one or more embossed patterns forming raised and recessed areas in the body 6 of the container 1, such that the cross-section of the body 6 in a plane perpendicular to axis A is not cylindrical and symmetrical over the entire height of the body 6, measured along axis A. In this case, the area to be treated 8 has no pattern and therefore does not include such raised areas and hollows, so that the wall of the body 6 is substantially smooth in the area to be treated 8.

The transport device 2 is designed to transport one or more containers 1 along a path of movement such that the container 1 passes during this path of movement in front of the laser treatment device 4 so that this laser treatment device 4 applies the laser treatment to the area to be treated 8 on the body 6 of the container 1. In order to ensure that the area to be treated 8 extends in front of the laser treatment device 4, the container 1 must therefore be angled, as will now be described.

To enable the orientation of the container 1, the laser treatment facility comprises, upstream of the laser treatment device 4 according to the movement path, at least one detection device 10 and one orientation device 12 for the container 1. “Upstream of the laser treatment device 4” means that the container 1 passes through the detection device 10 and the orientation device 12 before passing in front of the laser treatment device 4 when the container 1 is transported by the transport device 2 along the movement path.

The detection device 10 is designed to detect the position of the area to be treated 8 on the body 6 of the container 1. To this end, the detection device 10 comprises, for example, at least one image acquisition device 14 designed to acquire several images of the body of the container 1 at different angular positions relative to the axis A of the container 1. To this end, the detection device 10 further comprises a device 16 for rotating the container 1 about its axis A in front of the image acquisition device 14. Thus, the rotation device 16 allows the container 1 to be rotated in front of the image acquisition device 14, which acquires images at regular intervals of the container 1 in different angular positions, and an analysis module (not shown) analyzes the acquired images to detect the image or images in which the area to be treated 8 is present and deduces the angular position of the area to be treated 8 on the body of the container 1. Such a detection device 10 is described, for example, in document WO 2021/063788, and those skilled in the art may refer to this document for further details on the detection device 10.

The rotation device 16 is, for example, formed by a turntable designed to receive a bottom of the container 1, as shown in FIG. 2. The axis of rotation of the turntable coincides with the axis A of the container 1 when the latter is placed on the turntable.

Advantageously, detection of the area to be treated 8 is performed while the container 1 is moving along part of the path of travel of the container 1. To this end, the transport device 2 comprises, for example, a steering wheel 18 that can rotate about a rotation axis and carries the rotation device 16 so as to move it along a circular path. The axis of rotation of the orientation wheel 18 is substantially parallel to the axis A of the container 1 when the latter is placed on the rotation device 16. Thus, the container 1 rotates on its own axis thanks to the rotation device and is simultaneously moved along a portion of a circle thanks to the orientation wheel 18.

The portion of the circle along which the container 1 is moved by the orientation wheel 18 thus forms part of the path of movement of the container 1 and extends between an entrance 20 and an exit 22. The entrance 20 corresponds to the point, or area, of the circular path defined by the orientation wheel 18 at which the container 1 is placed on the rotation device 16 to be transported along a part of this circular path. The exit 22 corresponds to the point, or area, of the circular path defined by the orientation wheel 18 at which the container leaves the rotation device 16 and the orientation wheel 18 to be moved by the transport device 2 along another part of the movement path, as will be described later. The portion of the circle between the entrance 20 and the exit 22 extends only over part of the circular path defined by the orientation wheel 18, i.e., the rotation device 16 moves without a container on another part of this circular path when the rotation device 16 moves from the exit 22, where the container 1 taken over by the rotation device 16, to the entrance 20, where a new container 1 can be picked up by the rotating device 16.

In order to hold the container 1 on the rotating device 16 when it is transported by the orientation wheel 18, the transport device 2 further comprises at least one gripping device allowing the container 1 to rotate on itself. To this end, the gripping device comprises, for example, at least one clamp 24 designed to hold the container 1 by its neck and to allow it to rotate on itself when the bottom of the container 1 rests on the turntable of the rotating device 16, as shown in FIG. 2. The clamp 24 is carried by the orientation wheel 18 so as to move along the circular path defined by the latter. At the entrance 20, when the container 1 is placed on the turntable, the neck of the container 1 engages with the clamp 24 and, at the exit 22, when the container 1 leaves the turntable, the neck of the container 1 disengages from the clamp 24, as will be described in more detail below.

The image acquisition device 14 extends in front of a part of the path of travel of the container 1, for example formed by an angular sector of the circular path defined by the orientation wheel 18, as shown in FIG. 1. More specifically, the image acquisition device 14 extends, for example, in front of an angular sector extending in the vicinity and downstream of the entrance 20 of the orientation wheel 18 to an intermediate point 26 between the entrance 20 and the exit 22 of the orientation wheel 18. Between the entrance 20 and the intermediate point 26, a plurality of images of the body 6 of the container 1 are thus acquired and the angular position of the area to be treated 8 on the body 6 is determined by the analysis module.

Downstream of the detection device 10, the orientation device 12 is designed to orient the container 1 according to the angular position of the area to be treated 8 detected by the detection device 10 as described above. More specifically, the orientation device 12 is arranged so that the area to be treated 8 is positioned in front of the laser treatment device 4 when the container 1 is moved in front of this laser treatment device 4, as will be described in more detail below. To this end, the orientation device 12 comprises a calculation module designed to calculate the necessary angle of rotation of the container about its axis A to place the container 1 in an angular position in which the area to be treated 8 is in a desired angular orientation according to the angular position of the area to be treated 8 on the body 6 of the container 1 determined by the detection device 10. The desired angular orientation refers to the angular orientation of the body 6 of the container 1 about its axis in which the area to be treated 8 is located in front of the laser treatment device 4 when the container 1 is moved in front of this laser treatment device 4. The orientation device 12 further comprises a control module for a device for rotating the container 1, designed to control the rotation device 16 so that it rotates the container 1 by the angle of rotation calculated by the control module. Advantageously, the rotation device controlled by the control module is the rotation device 16 used to rotate the container 1 in front of the image acquisition device 14. Advantageously also, according to the embodiment described above, the orientation of the container 1 by the orientation device 12 is performed while the container is transported by the orientation wheel 18 from the intermediate point 26 to the exit 22 of the orientation wheel 18. More specifically, the control module is designed to adjust the speed of rotation of the container 1 according to the angle of rotation required to achieve the desired angular orientation of the area to be treated 8 based on the angular position of the area to be treated 8 determined by the detection device 10. In other words, the greater the angle of rotation required to place the container 1 in the desired angular orientation, the greater the speed of rotation of the container 1 about its axis. The rotation speed is adjusted so that the area to be treated 8 on the container 1 reaches the desired angular orientation before or when the container 1 reaches the exit 22 of the orientation wheel 18. During this orientation, container 1 is held by clamp 24 so that it can rotate about its axis A by the angle of rotation calculated by the calculation module.

Thus, when the container 1 is placed in any orientation on the rotation device 16 at the entrance 20 of the orientation wheel 18, it first passes in front of the image acquisition device 14 and the angular position of the area to be treated 8 is determined while container 1 moves from the inlet 20 to the intermediate point 26. Then, when the container moves from the intermediate point 26 to the exit 22, it is oriented by the orientation device 12 so that the area to be treated 8 is in the desired angular orientation at the exit 22 of the orientation wheel 18. As will be described later, the fact that the detection of the area to be treated 8 and its orientation is performed while the container 1 is moved by an orientation wheel 18 dedicated to these steps is particularly advantageous, especially when the laser treatment facility is designed to treat a succession of containers 1.

It is understood that the analysis module of the detection device 10, the calculation module, and the control module of the orientation device 12 may form part of a single control unit, controlling, for example, the entire laser treatment facility.

As mentioned above, the laser treatment facility is, according to one embodiment, designed to treat a succession of containers 1 moving along the path of movement one after the other. For this purpose, the orientation wheel 18 is designed to move the succession of containers 1 one after the other from the inlet 20 to the outlet 22 so that the area to be treated 8 on each container 1 is positioned at the desired angular orientation at the outlet 22 of the orientation wheel 18. The orientation wheel 18 then carries a plurality of devices 16 for rotating containers 1 and a plurality of clamps 24 for rotating the containers 1 so that they pass one after the other in front of the image acquisition device 14 and then orienting them so that the areas to be treated 8 are positioned at the desired orientation at the outlet 22 of the orientation wheel 18.

The containers 1 are conveyed to the inlet 20 of the orientation wheel 18 by an upstream part of the transport device 2 shown in FIG. 1 and designed to place the containers 1 at the pitch of the orientation wheel 18, the pitch corresponding to the distance between two successive rotation devices 16 carried by the orientation wheel 18. For this purpose, the upstream part of the transport device 2 comprises, for example, a stepping device 28 and a stabilizing wheel 30.

The stepping device 28 is, for example, formed by a passage 32 extending between two screw conveyors 34 between an inlet 36 and an outlet 38. The containers 1 are introduced into the laser treatment facility at the inlet 36 of the passage 32, for example lying against each other, and circulate to the outlet 38 of the passage 32 between the two screw conveyors 34, the screw pitch of which is designed to gradually separate the containers 1 from each other so that they extend at a distance corresponding to the pitch of the orientation wheel 18 at the outlet 38 of the passage 32. At the exit of the passage 32, the containers 1 are transported to the entrance 20 of the orientation wheel 18 by the stabilizing wheel 30, which is rotatable about an axis of rotation parallel to the axis of rotation of the orientation wheel 18 and which comprises, for example, a plurality of notches 40 for receiving the containers 1. The stabilizing wheel 30 is designed to adapt the speed of the containers 1 to the speed of rotation of the orientation wheel 18 and to allow each container 1 to be placed on a turntable and in a clamp 24 at the entrance to the orientation wheel 18. The containers 1 then arrive at the orientation wheel 18 in any orientation, while they exit it in a desired angular position, as described above.

At the exit 22 of the orientation wheel 18, the container(s) 1 placed in the desired angular position by the orientation device 12 are transferred to a treatment wheel 42 designed to move the container(s) 1 to another part of the path of movement during which laser treatment is applied by a laser treatment device 4 to the or each area to be treated 8 on the or each container 1.

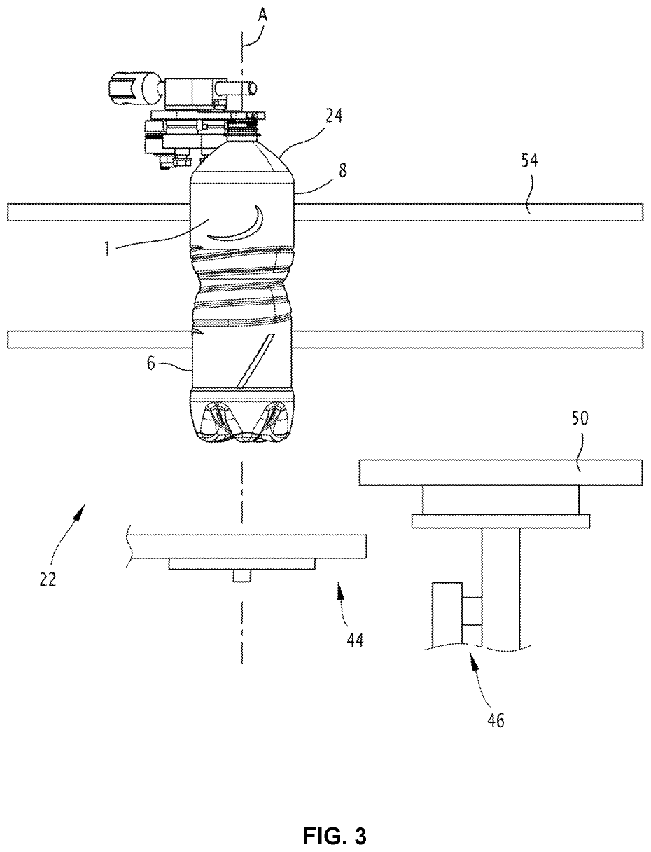

In one embodiment, the treatment wheel 42 is separate from the orientation wheel 18 and extends downstream of the orientation wheel 18 along the path of movement of the container 1. Each container 1 is transferred from the orientation wheel 18 to the treatment wheel 42 in a transfer area 44 extending between the outlet 22 of the orientation wheel 18 and an inlet 46 of the treatment wheel 42, as shown in FIG. 3.

In the transfer area 44, a container 1, having reached the outlet 22 of the orientation wheel 18 and being in a desired angular orientation, is transferred to the treatment wheel 42 while maintaining the angular orientation of the container 1 so that the area to be treated 8 is in front of a laser treatment device 4 carried by the treatment wheel 42, as will be described later. In other words, the desired orientation, acquired by means of the orientation device 12 of container 1, is maintained in the transfer area 44, the rotation of container 1 about its axis A being stopped in this transfer area 44.

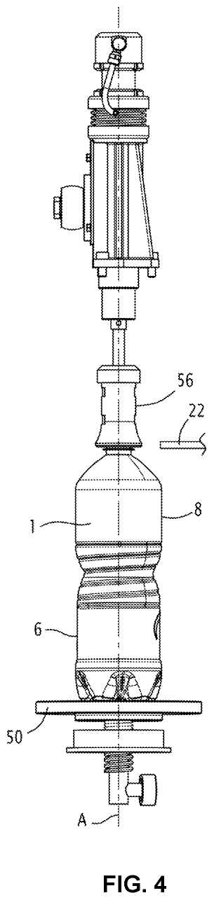

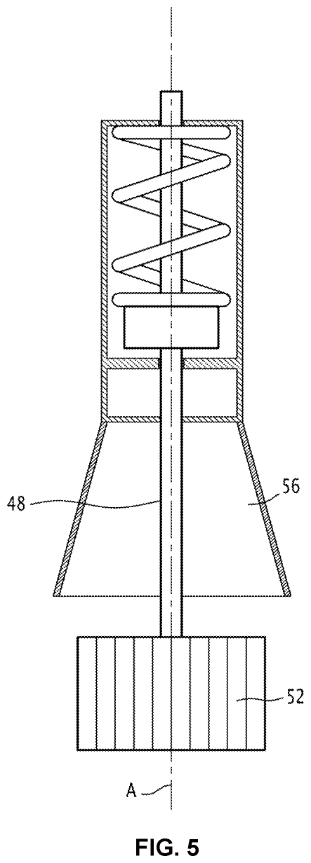

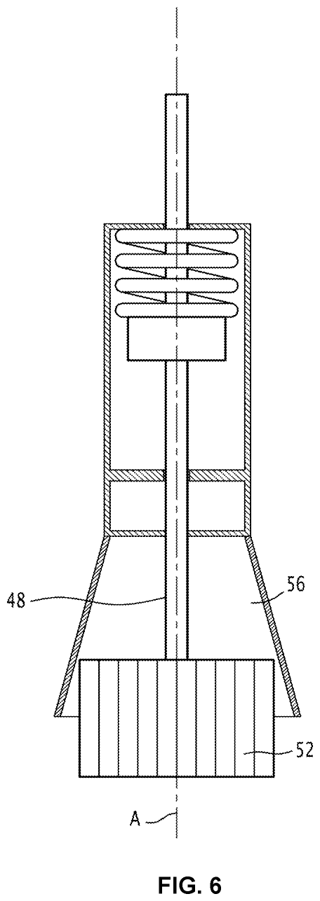

To do this, the gripping device of the transport device 2 is designed to maintain the orientation of the container 1 between the exit 22 of the orientation wheel 18 and the entrance 46 of the treatment wheel 42. To this end, the gripping device comprises, in addition to the clamp(s) 24, at least one support finger 48 (FIGS. 5 and 6) and a fixed plate 50 (FIGS. 3 and 4) designed to immobilize the container about its axis A between the fixed plate 50, receiving the bottom of the container 1, and the support finger 48 resting on a cap 52 of the container 1. The support finger 48 and the fixed plate 50 are carried by the treatment wheel 42 in front of each other along the axis A of the container and move along the circular path defined by the treatment wheel 42.

In transfer area 44, the container 1 moves from the orientation wheel 18, where it is held by a turntable of the rotation device 16 and by one of the clamps 24 of the gripping device, to the treatment wheel 42, where it is held by a fixed plate 50 and a support finger 48 of the gripping device, as shown in FIG. 3.

To this end, the circular path defined by the orientation wheel 18 and the circular path defined by the treatment wheel 42 intersect in the transfer area 44, as shown in FIG. 1. In other words, in the transfer area 44, the exit 22 of the orientation wheel 18 and the entrance 46 of the treatment wheel 42 are adjacent to each other according to the path of movement of the container 1. In this transfer area 44, the turntable supporting the container 1 is designed to lower along axis A so as to be moved away from the bottom of the container 1 while the clamp 24 continues to hold the container 1 by its neck. At the same time, the support finger 48 is lowered along axis A to rest on the cap 52 of container 1, and the bottom of container 1 is placed on the fixed plate 50. This step is performed, for example, while container 1 slides along a ramp 54 parallel to the circular path defined by the orientation wheel 18, preventing container 1 from moving away from the orientation wheel 18 under the effect of centrifugal force. Thus, the transition from the orientation wheel 18 to the treatment wheel 42 of container 1 occurs when container 1 stops rotating and its area to be treated 8 is oriented according to the desired angular position and is firmly held in this position by the part of the gripping device carried by the treatment wheel 42.

When container 1 is held between the fixed plate 50 and the support finger 48, the area to be treated 8 is located in front of the laser treatment device 4 carried by the treatment wheel 42 and the laser treatment is applied to the area to be treated 8 while the container 1 is transported along another part of the movement path by the treatment wheel 42 between the inlet 46 of the treatment wheel 42 and an outlet thereof (not shown). According to one embodiment, when the container 1 is picked up by the part of the gripping device carried by the treatment wheel 42, the container 1 is centered on the fixed plate 50 by means of a bell 56 placed around the cap 52 of the container 1 while the support finger 48 is pressed against the cap 52, as shown in FIGS. 5 and 6.

As indicated above, the laser treatment is, for example, laser marking of a pattern on the area to be treated 8, for example to display text on the area to be treated 8. The laser treatment device 4 is then, for example, a laser head designed to emit laser radiation towards the area to be treated 8 on the container 1 extending in front of the laser treatment device. For this purpose, the laser treatment device 4 comprises, along an optical path, at least one optical laser marking head equipped with a laser head unit and an optical system for focusing a laser beam in order to generate a mark at the area to be treated 8. More specifically, the marking is obtained, for example, by ablation, coloring or discoloration, engraving or foaming of the material of the container 1 in the area to be treated 8. Such laser treatment is particularly suitable for polymer containers. In the case of marking by foaming, the laser beam is projected in such a way as to generate bubbles and particles of degraded material throughout all or part of the thickness of the wall of the container body 1 in the area to be treated 8.

When the laser treatment facility is designed to treat a succession of containers 1 as described above, the treatment wheel 42 carries several laser treatment devices 4 associated with a plurality of fixed trays 50, support fingers 48, and bells 56 so that laser treatment can be applied simultaneously to several containers 1 as they are transported from the inlet 46 to the outlet of the treatment wheel 42.

Providing an orientation wheel 18 separate from the treatment wheel 42 means that the time available for applying the laser treatment on the treatment wheel 42 is not reduced, since the entire circular path between the inlet 46 and the outlet can be devoted to applying the laser treatment. In addition, such a laser treatment facility makes it possible to save on the means used to orient the containers 1. In fact, by providing these means on a wheel separate from the treatment wheel 42, the number of rotation devices can be reduced, since the orientation wheel 18 has a significantly smaller diameter than the treatment wheel 42. For example, the orientation wheel 18 has twelve rotating plates, while the treatment wheel 42 has thirty-two laser treatment devices 4.

Although this is less advantageous, it is understood that the disclosure also applies to a laser treatment facility in which the orientation wheel and the treatment wheel are combined, so that the same carousel carries the detection device, the orientation device, and the laser treatment device. In this case, the area to be treated is detected in a first angular sector of the circular path defined by this carousel, orientation takes place in a second angular sector, and laser treatment takes place in a third angular sector.

The disclosed facility thus makes it possible to treat only a specific, limited area of a container, particularly when the container has a non-symmetrical shape, by effectively ensuring that the laser treatment is carried out in that area. Such a laser treatment facility is particularly advantageous for marking a container in which only a window is left substantially smooth to receive the marking.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of “about 0.1% to about 5%” should be interpreted to include not only the explicitly recited concentration of about 0.1% to about 5 %, but also include individual values (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

Therefore, at least the following is claimed:

1. A laser treatment facility for at least one container, the container comprising a body extending along an axis and at least one area to be treated extending over a part of the body of the container, the facility comprising:
a transport device for transporting the container, designed to transport the container along a path of movement,
at least one laser treatment device for laser treatment of the container, the laser treatment device extending in front of a part of a movement path, and laser treatment device configured to apply laser treatment to the container in the area to be treated;
wherein the laser treatment facility further comprises, upstream of the laser treatment device along the movement path:
a detection device configured to detect a position of the area to be treated; and
an orienting device for orienting the container, the orienting device configured to rotate the container about the axis at an angle of rotation determined according to a detected position of the area to be treated, said orienting device configured to place the area to be treated in an orientation in which the area to be treated extends in front of the laser treatment device when the container is transported in front of the laser treatment device.

2. The laser treatment facility as claimed in claim 1, wherein the detection device comprises:
at least one image acquisition device;
a rotation device for rotating the container configured to rotate the container about its axis in front of the at least one image acquisition device;
wherein the at least one image acquisition device is configured to acquire images of different parts of the container body; and
an analysis module configured to detect a position of the area to be treated from the images acquired by the image acquisition device.

3. The laser treatment facility as claimed in claim 2, wherein the transport device comprises an orientation wheel carrying the rotation device, wherein the orientation wheel is configured to transport the container over a part of the movement path, wherein the container rotates about its axis as the container travels over the part of the movement path.

4. The laser treatment facility as claimed in claim 1, wherein the transport device comprises a treatment wheel carrying the laser treatment device, wherein the treatment wheel is configured to transport the container over a part of the movement path, the container being fixed relative to the laser treatment device with the area to be treated in front of the laser treatment device as it moves along said part of the movement path, wherein the laser treatment device is configured to apply laser treatment to the area to be treated during movement along the part of the movement path.

5. The laser treatment facility as claimed in claim 4, wherein the orientation wheel is separate from the treatment wheel, the treatment wheel extending downstream of the orientation wheel, the laser treatment facility comprising a transfer area in which the container is transferred from the orientation wheel to the treatment wheel.

6. The laser treatment facility as claimed in claim 5, wherein the orientation wheel carries the orientation device for the container, wherein the orientation device is arranged so that the container is in an angular position in which the area to be treated is in an angular orientation in which the area to be treated extends in front of the laser treatment device when the container is transported by the treatment wheel.

7. The laser treatment facility as claimed in claim 6, wherein the transport device comprises at least one gripping device for gripping the container when the container is transported by the orientation wheel and by the treatment wheel, the gripping device configured to allow the container to rotate about its axis when the container is transported by the orientation wheel and to prevent the rotation when the container is transported by the treatment wheel.

8. The laser treatment facility as claimed in claim 7, wherein the gripping device is configured to maintain an orientation of the container in the transfer area.

9. The laser treatment facility as claimed in claim 1, wherein the laser treatment device is configured to project a laser beam onto the area to be treated, wherein projection of the laser beam generates bubbles and particles of degraded material throughout all or part of a thickness of a wall of the body of the container at the area to be treated.

10. The laser treatment facility as claimed in claim 1, wherein the transport device is configured to transport a succession of containers along the movement path, the laser treatment facility comprising a plurality of laser treatment devices configured to apply laser treatment to the area to be treated on each container of the succession of containers.
